(19) United States
(12) Patent Application Publication
(10) Pub. No.: US 2026/0336574 A1
(43) Pub. Date: Oct. 29, 2026

(54) BRAKE SYSTEM AND CONTROL METHOD THEREOF

(71) Applicant: HL MANDO CORPORATION, Gyeonggi-do (KR)

(72) Inventor: Dongil SEO, Gyeonggi-do (KR)

(73) Assignee: HL MANDO CORPORATION, Gyeonggi-do (KR)

(21) Appl. No.: 19/348,236

(22) Filed: Oct. 2, 2025

(30) Foreign Application Priority Data
Apr. 28, 2025 (KR) 10-2025-0055796

(51) Int. Cl. B60T 7/12; B60T 8/171

(52) U.S. Cl. CPC B60T 7/122; B60T 8/171; B60T 2270/402

(57) ABSTRACT

A brake system comprises a first electro-mechanical brake including a first motor and a ratchet unit; and a first electro-mechanical brake controller configured to control the electro-mechanical brake, wherein the first electro-mechanical brake controller is configured, based on an engagement control signal of the first parking brake, to control the first motor to rotate in a first direction, in which a clamping force increases, and then to rotate in a second direction opposite to the first direction, and to perform controlling the first motor to rotate in the first direction and/or transmitting status information of the first electro-mechanical brake, based on a comparison between a first clamping force of the first electro-mechanical brake and a reference clamping force.

### CROSS-REFERENCE TO RELATED APPLICATIONS

Pursuant to 35 U.S.C. § 119, this application claims the benefit of earlier filing date and right of priority to Korean Application No. 10-2025-0055796, filed on Apr. 28, 2025, the contents of which are all incorporated by reference herein in its entirety.

### BACKGROUND

### Field

The present invention relates to a brake system and controlling method thereof.

### Description of the Related Art

A brake system for performing braking is essentially installed in a vehicle, and a hydraulic brake has been mainly installed in a conventional vehicle.

Recently, Electro-Mechanical Brakes (EMB), which generate braking force by operating electric actuators such as motors based on electrical signals that convey the driver's braking intention, have been developed.

The electro-mechanical brake is a device that generates braking force using an electric actuator instead of hydraulic pressure, offering superior braking response and control performance compared to hydraulic brakes. In addition, the electro-mechanical brake allows for more efficient design and weight reduction, as well as easier maintenance compared to a hydraulic brake system.

Meanwhile, when the electro-mechanical brake operates under the control of a controller, there are cases where the brake fails to engage due to internal or external factors, requiring a retry to initiate engagement again. In such cases, if the controller of the electro-mechanical brake delays the decision to perform a retry, the braking force of the vehicle may drop below a certain level, potentially causing issues such as vehicle rollback on slopes or inclines.

### SUMMARY

One aspect of the present disclosure is to provide a brake system and a control method thereof, which can quickly determine the necessity of re-engagement of the parking brake and execute the re-engagement if the parking brake fails to engage during the engagement control of the electro-mechanical brake's parking brake.

One aspect of the present disclosure is to provide a brake system and a control method thereof, which, if the parking brake of the electro-mechanical brake provided on the rear wheels of the vehicle fails to engage during engagement control, assists the braking force of the vehicle through brake control of the electro-mechanical brake provided on the front wheels of the vehicle, and further executes the re-engagement of the parking brake.

According to one aspect of the present disclosure, there is provided a brake system comprising: a first electro-mechanical brake including a first motor and a ratchet unit and configured to brake a first wheel based on driving the first motor and to engage or disengage a first parking brake through operating the ratchet unit; a first electro-mechanical brake controller configured to control the first motor and the ratchet unit; and a controller electrically connected or communicatively connected to the first electro-mechanical brake controller, wherein the first electro-mechanical brake controller is configured, based on receiving an engagement control signal of the first parking brake from the controller, to control the first motor to rotate in a first direction, in which a clamping force increases, and then to rotate in a second direction opposite to the first direction, and wherein, during control of the first motor to rotate in the second direction, the first electro-mechanical brake controller is configured to perform at least one of controlling the first motor to rotate in the first direction or transmitting status information of the first electro-mechanical brake, based on a comparison between a first clamping force of the first electro-mechanical brake and a reference clamping force.

The first electro-mechanical brake controller may control the first motor to rotate in the first direction if the first parking brake is disengaged until the first clamping force of the first electro-mechanical brake reaches the reference clamping force during control of the first motor to rotate in the second direction.

The first electro-mechanical brake controller may identify whether the first parking brake is engaged based on a signal output from a position sensor of the first motor during control of the first motor to rotate in the second direction.

The first electro-mechanical brake may further include a drive pulley configured to rotate based on driving force of the first motor, and the ratchet unit may engage or disengage the first electro-mechanical brake based on rotational force of the drive pulley.

The first electro-mechanical brake controller may identify whether the drive pulley is rotating based on the signal output from the position sensor of the first motor during control of the first motor to rotate in the second direction, and identify that the first parking brake is engaged if the drive pulley is not rotating.

In response to control of the first motor to rotate in the first direction, the first electro-mechanical brake controller may control the first motor to rotate in the second direction based on a clamping force generated by the first electro-mechanical brake exceeding a target clamping force of the first parking brake for a preset time.

The brake system may further comprise a second electro-mechanical brake including a second motor and configured to brake a second wheel based on driving of the second motor, and a second electro-mechanical brake controller configured to control the second motor, the controller may transmit a control signal including a target braking clamping force to the second electro-mechanical brake controller based on reception of the status information from the first electro-mechanical brake controller, and the second electro-mechanical brake controller may control the second motor such that a second clamping force of the second electro-mechanical brake increases based on reception of the control signal including the target braking clamping force.

The controller may identify disengagement of the first parking brake until a first clamping force of the first electro-mechanical brake reaches the reference clamping force, during control of the first motor to rotate in the second direction based on reception of the status information, and transmit a control signal including the target braking clamping force to the second electro-mechanical brake controller based on identification of disengagement of the first parking brake.

The controller may identify a slope of a road surface where a vehicle having the brake system is located based on reception of a signal output from an acceleration sensor of the vehicle, and identify the reference clamping force corresponding to the slope of the road surface among pre-stored reference clamping forces, each corresponding to a road surface slope, wherein the first electro-mechanical brake controller is configured to receive the reference clamping force from the controller.

The controller may identify the target braking clamping force corresponding to the slope of the road surface among the pre-stored reference clamping forces.

According to one aspect of the present disclosure, there is provided a control method of a brake system comprising a first electro-mechanical brake including a first motor and a ratchet unit and configured to brake a first wheel based on driving the first motor and to engage or disengage a first parking brake through operating the ratchet unit, a first electro-mechanical brake controller configured to control the first motor and the ratchet unit, and a controller electrically connected or communicatively connected to the first electro-mechanical brake controller, the control method comprising: controlling, by the first electro-mechanical brake controller, the first motor to rotate in a first direction, in which a clamping force increases, and then to rotate in a second direction opposite to the first direction, based on receiving an engagement control signal of the first parking brake from the controller; and during control of the first motor to rotate in the second direction, performing, by the first electro-mechanical brake controller, at least one of controlling the first motor to rotate in the first direction or transmitting status information of the first electro-mechanical brake, based on a comparison between a first clamping force of the first electro-mechanical brake and a reference clamping force.

The controlling of the first motor to rotate in the first direction may be performed, based on the first parking brake being disengaged until the first clamping force of the first electro-mechanical brake reaches the reference clamping force during control of the first motor to rotate in the second direction.

The control method further comprises identifying whether the first parking brake is engaged based on a signal output from a position sensor of the first motor during control of the first motor to rotate in the second direction.

The first electro-mechanical brake further may include a drive pulley configured to rotate based on driving force of the first motor, and the ratchet unit may engage or disengage the first electro-mechanical brake based on rotational force of the drive pulley.

The identifying of the whether the first parking brake is engaged may include identifying whether the drive pulley is rotating based on the signal output from the position sensor of the first motor during control of the first motor to rotate in the second direction, and identifying that the first parking brake is engaged if the drive pulley is not rotating.

The controlling of the first motor to rotate in the second direction is performed based on a clamping force generated by the first electro-mechanical brake exceeding a target clamping force of the first parking brake for a preset time in response to control of the first motor to rotate in the first direction.

The brake system may further comprise a second electro-mechanical brake including a second motor and configured to brake a second wheel based on driving of the second motor, and a second electro-mechanical brake controller configured to control the second motor, the control method may further comprise: transmitting, by the controller, a control signal including a target braking clamping force to the second electro-mechanical brake controller based on reception of the status information from the first electro-mechanical brake controller, and controlling, by the second electro-mechanical brake controller, the second motor such that a second clamping force of the second electro-mechanical brake increases based on reception of the control signal including the target braking clamping force.

The transmitting of the control signal including the target braking clamping force to the second electro-mechanical brake controller may include identifying, by the controller, disengagement of the first parking brake until a first clamping force of the first electro-mechanical brake reaches the reference clamping force, during control of the first motor to rotate in the second direction based on reception of the status information, and transmitting, by the controller, a control signal including the target braking clamping force to the second electro-mechanical brake controller based on identification of disengagement of the first parking brake.

The control method may further comprise identifying, by the controller, a slope of a road surface where a vehicle having the brake system is located based on reception of a signal output from an acceleration sensor of the vehicle, and identifying, by the controller, the reference clamping force corresponding to the slope of the road surface among pre-stored reference clamping forces, each corresponding to a road surface slope.

The control method may further comprise identifying, by the controller, the target braking clamping force corresponding to the slope of the road surface among the pre-stored reference clamping forces.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram illustrating a configuration of a brake system according to one embodiment of the present disclosure.

FIG. 2 is a simplified cross-sectional view of a caliper brake according to one embodiment of the present disclosure.

FIG. 3 is a simplified perspective view of an actuator assembly of an electro-mechanical brake according to one embodiment of the present disclosure.

FIG. 4 is a cross-sectional view illustrating a ratchet unit and a first drive pulley of the actuator assembly according to one embodiment of the present disclosure.

FIG. 5 is a graph illustrating the clamping forces of the front and rear wheel electro-mechanical brakes over time when the front and rear wheel electro-mechanical brakes operate normally under the control of the brake system 1 according to an embodiment.

FIG. 6 is a graph illustrating a clamping force of a rear wheel electro-mechanical brake according to re-engagement control of a parking brake by a conventional brake system.

FIG. 7 is a graph illustrating clamping forces of front and rear electro-mechanical brakes over time when the front and rear electro-mechanical brakes are operated according to control of a brake system according to one embodiment of the present disclosure.

FIG. 8 is a graph illustrating clamping forces of front and rear wheel electro-mechanical brakes over time when the front and rear wheel electro-mechanical brakes are operated according to control of a brake system according to one embodiment of the present disclosure.

FIG. 9 is a flowchart illustrating operations of an electro-mechanical brake controller of a brake system according to one embodiment of the present disclosure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals refer to like elements throughout the specification. The present specification does not describe all elements of the embodiments, and any content that is general in the technical field to which the present disclosure belongs or that overlaps between the embodiments is omitted. The terms “portion, module, element, or block” used in the specification may be implemented in software or hardware, and according to the embodiments, a plurality of “portions, modules, elements, or blocks” may be implemented as a single element, or a single “portion, module, element, or block” can include a plurality of elements.

Throughout the specification, when a part is said to be “connected” to another part, this includes not only direct connection but also indirect connection, and indirect connection includes connection via a wireless communications network.

Additionally, when a part is said to “include” a component, this does not mean that it excludes other components, unless otherwise specifically stated, but rather that it may include other components.

Throughout the specification, when it is said that an element is located “on” another element, this includes not only cases where an element is in contact with another element, but also cases where another element exists between the two elements.

The terms first, second, and the like are used to distinguish one component from another, and the components are not limited by the aforementioned terms.

Singular expressions include plural expressions unless the context clearly indicates otherwise.

The identification codes in each step are used for convenience of explanation and do not describe the order of each step. Each step may be performed in a different order than specified unless the context clearly indicates a specific order.

Hereinafter, the operating principle and embodiments of the present disclosure will be described with reference to the attached drawings.

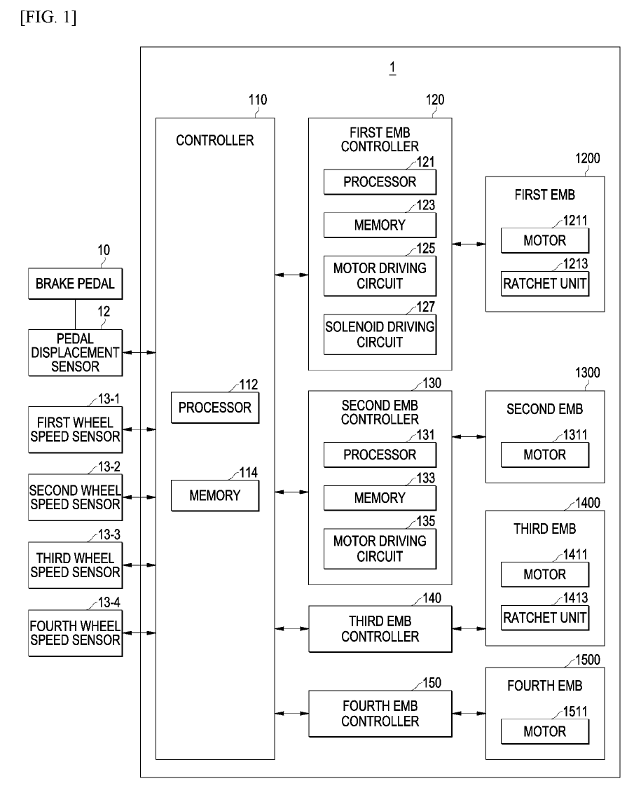

FIG. 1 is a diagram illustrating a configuration of a brake system according to one embodiment of the present disclosure.

Referring to FIG. 1, a brake system 1 may include a controller 110, a first electro-mechanical brake controller 120, a second electro-mechanical brake controller 130, a third electro-mechanical brake controller 140, a fourth electro-mechanical brake controller 150, a first electro-mechanical brake 1200, a second electro-mechanical brake 1300, a third electro-mechanical brake 1400, and/or a fourth electro-mechanical brake 1500.

The controller 110 may be electrically connected or communicatively connected to each component of the brake system 1, for example, the first, second, third and/or fourth electro-mechanical brake controllers 120, 130, 140, and/or 150 to transmit a control signal to the first, second, third and/or fourth electro-mechanical brake controllers 120, 130, 140, and/or 150. For example, although omitted in FIG. 1, the controller 110 may include a communication circuit.

The controller 110 may be electrically connected or communicatively connected to the pedal displacement sensor 12 for the brake pedal 10 of the vehicle and/or the first, second, third and/or fourth wheel speed sensors 13-1, 13-2, 13-3, and/or 13-4 provided on each wheel of the vehicle. The controller 110 may receive signals output from the pedal displacement sensor 12 and/or the first, second, third and/or fourth wheel speed sensors 13-1, 13-2, 13-3, and/or 13-4.

The pedal displacement sensor 12 may detect displacement of the brake pedal 10 (or acquire displacement information).

For example, the pedal displacement sensor 12 may be physically connected to the brake pedal 10 to measure movement of the brake pedal 10. The pedal displacement sensor 12 may sense a moving distance from a reference position of the brake pedal 10, a moving speed, and/or the like.

The pedal displacement sensor 12 may provide a signal corresponding to the acquired displacement of the brake pedal 10 to the controller 110, that is, an electrical signal corresponding to the moving distance and/or moving speed of the brake pedal 10 to the controller 110.

The first, second, third and/or fourth wheel speed sensors 13-1, 13-2, 13-3, and/or 13-4 may detect a corresponding wheel speed (or also referred to as the wheel rotation speed).

For example, the first wheel speed sensor 13-1 may be provided on the first wheel, the second wheel speed sensor 13-2 may be provided on the second wheel, the third wheel speed sensor 13-3 may be provided on the third wheel, and the fourth wheel speed sensor 13-4 may be provided on the fourth wheel. For example, the first wheel and the third wheel may be rear wheels of the vehicle, and the second wheel and the fourth wheel may be front wheels of the vehicle.

Each of the first, second, third and/or fourth wheel speed sensors 13-1, 13-2, 13-3, and/or 13-4 may transmit an electrical signal corresponding to the rotational speed of the corresponding wheel to the controller 110.

The controller 110 may generate a target braking clamping force based on signals received from the pedal displacement sensor 12 and/or the first, second, third and/or fourth wheel speed sensors 13-1, 13-2, 13-3, and/or 13-4.

The controller 110 may transmit a control signal including a corresponding target braking clamping force to each of the first, second, third and/or fourth electro-mechanical brake controllers 120, 130, 140, and/or 150.

The controller 110 may transmit a parking brake engagement control signal using the first and/or third electro-mechanical brakes 1200 and/or 1400 to the first and/or third electro-mechanical brake controllers 120 and/or 140, based on the detection of the vehicle being stopped or the reception of a signal output from a parking switch (not shown).

For example, the controller 110 may identify the stopped state of the vehicle based on information acquired through a signal output from a speed sensor that acquires the speed of the vehicle and/or the first and/or third wheel speed sensors 13-1 and/or 13-3, and may transmit a parking brake engagement control signal to the first and/or third electro-mechanical brake controllers 120 and/or 140 based on the identification of the stopped state of the vehicle. Furthermore, the controller 110 may transmit a parking brake engagement control signal to the first and/or third electro-mechanical brake controllers 120 and/or 140 based on the reception of the signal output from the parking switch according to the driver's operation.

The controller 110 may provide the first and/or third electro-mechanical brake controllers 120 and/or 140 with a parking brake disengagement control signal according to the reception of the signal output from the parking switch (not shown) of the vehicle.

The controller 110 may be referred to as a brake control unit (BCU), and may include an electronic control unit (ECU).

The controller 110 may include a processor 112 and/or a memory 114.

The processor 112 may process the out signals of the pedal displacement sensor 12 and/or the first, second, third and/or fourth wheel speed sensors 13-1, 13-2, 13-3, and/or 13-4 to determine a target braking clamping force.

The processor 112 may generate a control signal including a target braking clamping force and transmit the control signal to the first, second, third and/or fourth electro-mechanical brake controllers 120, 130, 140, and/or 150.

The processor 112 may transmit an apply and release signals of the parking brake to the first and/or third electro-mechanical brake controllers 120 and/or 140.

The memory 114 may store or record programs and data for implementing an operation of controlling components included in the brake system 100 by the processor 112.

The memory 114 may provide the stored program and data to the processor 112 and may store temporary data generated during the operation of the processor 112.

For example, the memory 114 may include a volatile memory, such as Static Random Access Memory (S-RAM) and Dynamic Random Access Memory (D-RAM), and a non-volatile memory, such as Read Only Memory (ROM) and Erasable Programmable Read Only Memory (EPROM), Electrically erasable Programmable Read Only Memory (EEPROM), and flash memory.

The first electro-mechanical brake controller 120 may receive a target braking clamping force from the controller 110, and may control the first electro-mechanical brake 1200 to apply braking to the first wheel accordingly.

The second electro-mechanical brake controller 130 may receive a target braking clamping force from the controller 110, and may control the second electro-mechanical brake 1300 to apply braking to the second wheel accordingly.

The third electro-mechanical brake controller 140 may receive a target braking clamping force from the controller 110, and may control the third electro-mechanical brake 1400 to apply braking to the third wheel accordingly.

The fourth electro-mechanical brake controller 150 may receive a target braking clamping force from the controller 110, and may control the fourth electro-mechanical brake 1500 to apply braking to the fourth wheel accordingly.

The first electro-mechanical brake controller 120 may receive an engagement control signal or a disengagement control signal of the parking brake from the controller 110, and may control the first electro-mechanical brake 1200 to engage or disengage the parking brake based on the received signal.

The third electro-mechanical brake controller 140 may receive an engagement control signal or a disengagement control signal of the parking brake from the controller 110, and may control the third electro-mechanical brake 1400 to engage or disengage the parking brake based on the received signal.

The first electro-mechanical brake controller 120 may include a processor 121, a memory 123, a motor driving circuit 125, and/or a solenoid driving circuit 127.

The processor 121 may convert the target braking clamping force of the first electro-mechanical brake 1200 into the torque of the motor 1211 of the electro-mechanical brake 1200 to generate a signal for controlling the motor 1211.

The processor 121 may generate a signal for controlling the motor 1211 to control an engagement and/or disengagement of the parking brake of the first electro-mechanical brake 1200, and/or a signal for controlling the ratchet unit 1213 of the actuator assembly 120 to be described later.

The memory 123 may store or record programs and data for implementing an operation of controlling components included in the first electro-mechanical brake 1200 by the processor 121.

For example, the memory 123 may include a volatile memory, such as Static Random Access Memory (S-RAM) and Dynamic Random Access Memory (D-RAM), and a non-volatile memory, such as Read Only Memory (ROM) and Erasable Programmable Read Only Memory (EPROM), Electrically erasable Programmable Read Only Memory (EEPROM), and flash memory.

The motor driving circuit 125 may drive the motor 1211 of the first electro-mechanical brake 1200 based on the control signal of the processor 121. For example, the motor driving circuit 125 may receive a signal from the processor 121 and adjust the current of the motor 1211. A speed and a torque of the motor 1211 may be adjusted according to current adjustment of the motor 1211.

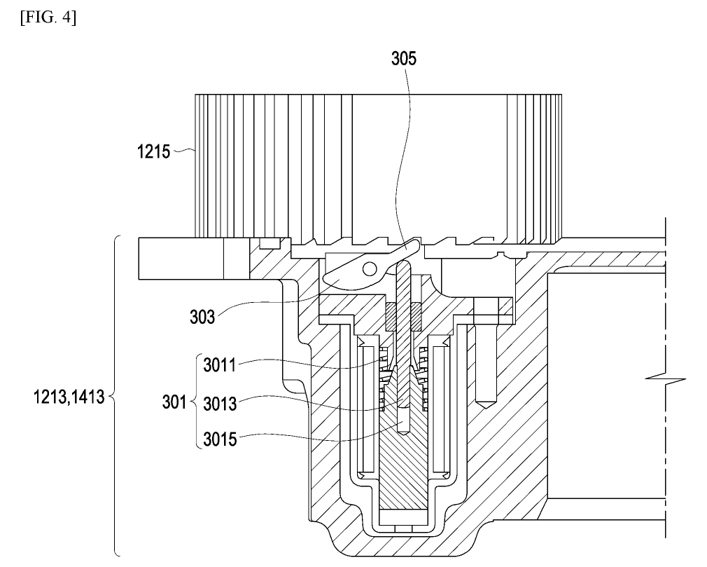

The solenoid driving circuit 127 may drive the solenoid driver 301 of FIG. 4 included in the ratchet unit 1213 of the first electro-mechanical brake controller 120 based on the control signal of the processor 121. For example, the solenoid driving circuit 127 may receive a signal from the processor 121 and provide an electrical signal so that the solenoid coil 3011 generates a magnetic field.

The second electro-mechanical brake controller 130 may include a processor 131, a memory 133, and/or a motor driving circuit 135.

The processor 131 may convert the target braking clamping force of the second electro-mechanical brake 1300 into the torque of the motor 1311 of the electro-mechanical brake 1300 to generate a signal for controlling the motor 1311.

The memory 133 may store or record programs and data for implementing an operation of controlling components included in the second electro-mechanical brake 1300 by the processor 131.

For example, the memory 133 may include a volatile memory, such as Static Random Access Memory (S-RAM) and Dynamic Random Access Memory (D-RAM), and a non-volatile memory, such as Read Only Memory (ROM) and Erasable Programmable Read Only Memory (EPROM), Electrically erasable Programmable Read Only Memory (EEPROM), and flash memory.

The motor driving circuit 135 may drive the motor 1311 of the second electric mechanical brake 1300 based on the control signal of the processor 121. For example, the motor driving circuit 135 may receive a signal from the processor 131 and adjust the current of the motor 1311. The speed and torque of the motor 1311 may be adjusted according to the current adjustment of the motor 1311.

Meanwhile, although not shown, the third electro-mechanical brake controller 140 may include a processor (not shown) operating similar to the processor 121 of the first electro-mechanical brake controller 120, a memory (not shown) operating similar to the memory 123, a motor driving circuit (not shown) operating similar to the motor driving circuit 125, and/or a solenoid driving circuit (not shown) operating similar to the solenoid driving circuit 127 and may control the third electro-mechanical brake 1400.

In addition, although not shown, the fourth electro-mechanical brake controller 150 may include a processor (not shown) operating similar to the processor 131 of the first electro-mechanical brake controller 130, a memory (not shown) operating similar to the memory 133, and/or a motor driving circuit (not shown) operating similar to the motor driving circuit 135 and may control the fourth electro-mechanical brake 1500.

The first electro-mechanical brake 1200 may be provided on the first wheel, may generate a braking force based on reception of a control signal from the first electro-mechanical brake controller 120, and may implement engagement of the parking brake and/or disengagement of the parking brake.

The first electro-mechanical brake 1200 may include a motor 1211 and a ratchet unit 1213.

The motor 1211 may have a rotary shaft, and the first electro-mechanical brake 1200 may generate a braking force according to a rotational driving force of the motor 1211.

The ratchet unit 1213 prevents the reverse rotation of the first electro-mechanical brake 1200 according to the rotational driving force of the motor 1211, ensuring that the braking force is stably maintained, and may implement the parking brake that engages the first electro-mechanical brake 1200.

The second electro-mechanical brake 1300 may be provided on the second wheel, may generate a braking force based on reception of a control signal from the second electro-mechanical brake controller 130.

The second electro-mechanical brake 1300 may include a motor 1311.

The motor 1311 may have a rotary shaft, and the second electro-mechanical brake 1300 may generate a braking force according to a rotational driving force of the motor 1311.

The third electro-mechanical brake 1400 may be provided on the third wheel, may generate a braking force based on reception of a control signal from the third electro-mechanical brake controller 140, and may implement engagement of the parking brake and/or disengagement of the parking brake.

The third electro-mechanical brake 1400 may include a motor 1411 and a ratchet unit 1413.

The motor 1411 may have a rotary shaft, and the third electro-mechanical brake 1400 may generate a braking force according to a rotational driving force of the motor 1411.

The ratchet unit 1413 prevents the reverse rotation of the third electro-mechanical brake 1400 according to the rotational driving force of the motor 1411, ensuring that the braking force is stably maintained, and may implement the parking brake that engages the third electro-mechanical brake 100.

The fourth electro-mechanical brake 1500 may be provided in the fourth wheel and may generate a braking force based on reception of a control signal from the fourth electro-mechanical brake controller 150.

The fourth electro-mechanical brake 1500 may include a motor 1511.

The motor 1511 may have a rotary shaft, and the fourth electro-mechanical brake 1500 may generate a braking force according to a rotational driving force of the motor 1511.

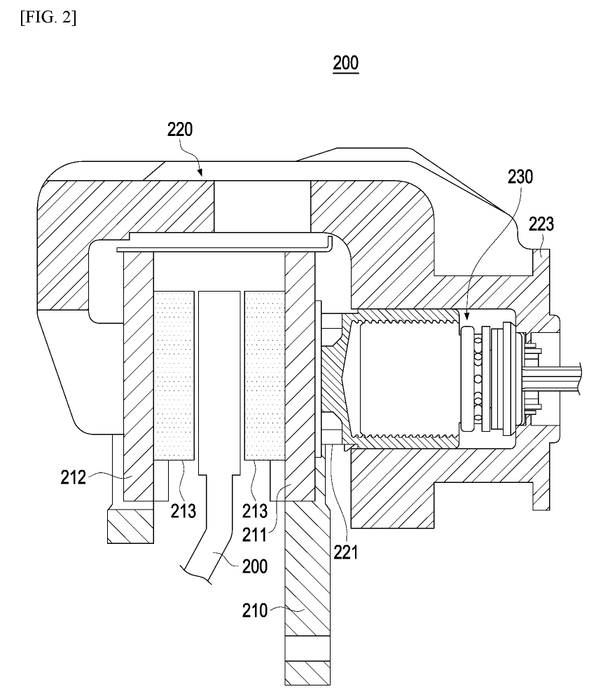

The first, second, third, and fourth electro-mechanical brakes 1200, 1300, 1400, and 1500 may include the caliper brake as shown in FIG. 2.

FIG. 2 is a simplified cross-sectional view of a caliper brake according to one embodiment of the present disclosure.

Referring to FIG. 2, the caliper brake 200 may include a brake disk 200 that rotates with the corresponding wheel, a pair of pad plates 211 and 212 that are provided to pressurize the brake disk 200, a brake pad 213 attached to one surface of each of the pair of pad plates 211 and 212 and, more specifically to one surface facing the brake disk 200, a carrier 210 provided with a pair of pad plates 211 and 212 to move forward and backward, a caliper housing 220 equipped with a cylinder 223 that is installed slidably in the carrier 210 and where the piston 221 is installed to move forward and backward by an actuating force from a power conversion unit 230, a power conversion unit 230 pressurizing the piston 221, a motor(not shown) with a rotary shaft (see 1211, 1311, 1411, 1511) and/or a motor actuator (not shown) that transmits rotational force to the power conversion unit 230 using the motor.

According to the above-described configuration, the rotational driving force of the motor(s) 1211, 1311, 1411, and 1511 is transmitted to the pad plates 211 and 212 through the power conversion unit 230 and the transmitted rotational driving force moves the pad plates 211 and 212 forward and backward to press the brake disk 200, thereby enabling the corresponding electro-mechanical brakes 1200, 1300, 1400, and 1500 to generate braking force.

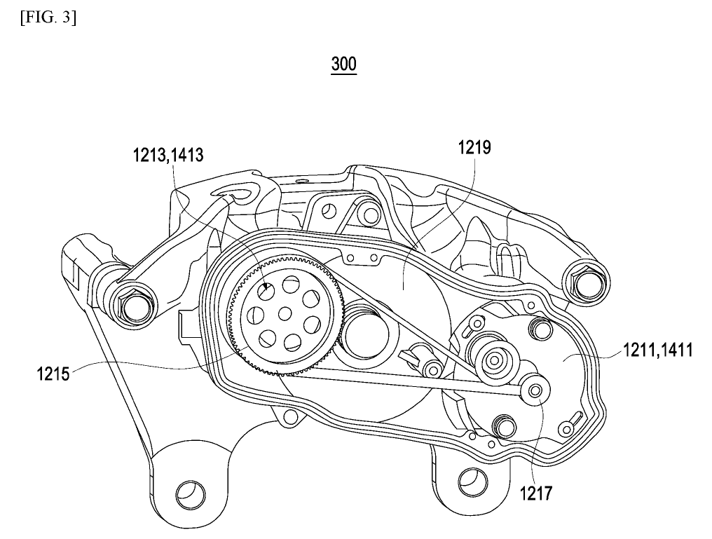

Meanwhile, the motor 1211, 1411 and the ratchet unit 1213, 1413 of the first and/or third electro-mechanical brakes 1200 and/or 1400 may be implemented as one actuator assembly as shown in FIG. 3.

FIG. 3 is a simplified perspective view of an actuator assembly of an electro-mechanical brake according to one embodiment of the present disclosure.

FIG. 4 is a cross-sectional view illustrating a ratchet unit and a first drive pulley of the actuator assembly according to one embodiment of the present disclosure.

Referring to FIG. 3, the actuator assembly 300 of each of the first and/or third electro-mechanical brakes 1200 and/or 1400 may include a motor 1211 or 1411, a ratchet unit 1213 or 1413, a first drive pulley 1215(also referred to as a driven pulley), a second drive pulley 1217(also referred to as a driving pulley), and a belt 1219.

A second drive pulley 1217 may be connected to the rotary shaft of motors 1211 and 1411, and the first drive pulley 1215 may be fixed by the ratchet units 1213 and 1413.

The first drive pulley 1215 and the second drive pulley 1217 may be rotatably connected to each other through a belt 1219.

According to the configuration of the actuator assembly 300 of FIG. 3, the rotational driving force of the motor 1211 or 1411 is transmitted to the first drive pulley 1215 through the second drive pulley 1217, so that the parking brake may be engaged or disengaged.

Meanwhile, referring to FIG. 4, the ratchet units 1213 and 1413 may include a solenoid driver 301, a pawl 303, and/or a torsion spring 305.

The solenoid driver 301 may rotate the pawl 303 to engage or prevent the pawl 303 from engaging with the teeth of the first drive pulley 1215.

The solenoid driver 301 may include a solenoid coil 3011, an armature 3013, and/or a pin 3015.

The solenoid coil 3011 may generate a magnetic field by an electrical signal from the electric mechanical brake controller 120.

The armature 3013 may move linearly, i.e., in a forward and backward direction, by a magnetic field generated inside the solenoid coil 3011. According to the forward or backward movement of the armature 3013, the pawl 303 may move to engage with or disengage from the teeth of the first drive pulley 1215, which is disposed above the ratchet unit 1213.

The pin 3015 may be press-fitted into the armature 3013 and may serve to push the pawl 303 according to the movement of the armature 3013.

The pawl 303 is moved by the armature 3013, and in this case, it may engage with or disengage from the teeth of the first drive pulley 1215.

The pawl 303 may engage with the teeth of the first drive pulley 1215 to engage the parking brake, or may move so as to disengage from the teeth of the first drive pulley 1215 to release the parking brake.

The torsion spring 305 may be provided on the pawl 303 to provide an elastic force for pushing the pawl 303 away from the first drive pulley 1215.

The first drive pulley 1215 may receive driving force from the motor(s) 1211 and 1411 and rotate, and the engagement or disengagement of the parking brake may be implemented by the rotational force of the first drive pulley 1215.

For example, the first drive pulley 1215 may include sawtooth protrusions, and when the pawl 303 is seated in a groove between the sawtooth protrusions, the parking brake may be engaged; otherwise, the parking brake may be released.

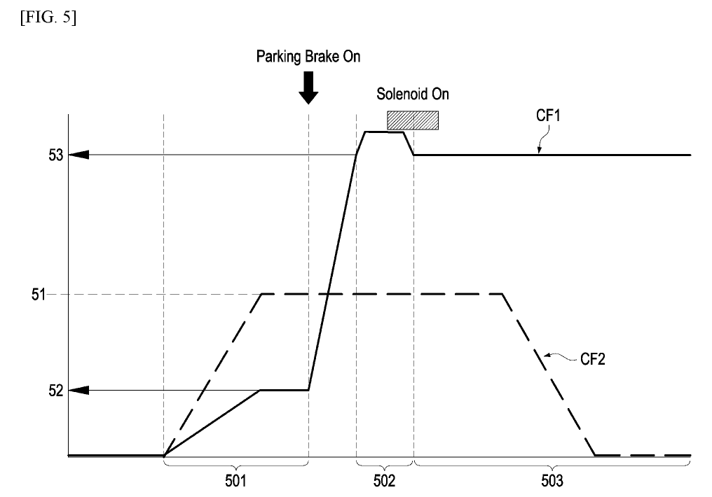

FIG. 5 is a graph illustrating the clamping forces of the front and rear wheel electro-mechanical brakes 1200, 1300, 1400, and 1500 over time when the front and rear wheel electro-mechanical brakes 1200, 1300, 1400, and 1500 operate normally under the control of the brake system 1 according to an embodiment.

Referring to FIG. 5, during the service braking control 501 by the electro-mechanical parking brake controller (e.g., the second and/or fourth electro-mechanical brake controllers 130 and/or 150), the electro-mechanical brakes provided on the front wheels (e.g., the second and/or fourth electro-mechanical brakes 1300 and/or 1500) may increase the clamping force CF1 up to a first target clamping force 51 of the service braking control, and then maintain the clamping force CF1. Additionally, during the service braking control by the electro-mechanical parking brake controller (e.g., the first and/or third electro-mechanical brake controllers 120 and/or 140), the electro-mechanical brakes provided on the rear wheels (e.g. the first and/or third electro-mechanical brakes1200 and 1400) may increase the clamping force CF2 up to a second target clamping force 52 (also referred to as a reference clamping force), which is lower than the first target clamping force 51 of the service braking control, and then maintain the clamping force CF2.

While the electro-mechanical brakes provided on the front wheels 1300 and 1500 maintain the clamping force CF2 corresponding to the first target clamping force 51, and the electro-mechanical brakes provided on the rear wheels 1200 and 1400 maintain the clamping force CF1 corresponding to the second target clamping force 52, the electro-mechanical parking brake controllers 120 and 140 may perform parking brake engagement control 502 of the parking brake on the rear wheels 1200 and 1400 through the parking brake on signal.

The electro-mechanical parking brake controllers 120 and 140 may rotate the motors 1211 and 1411 of the electro-mechanical brakes 1200 and 1400 provided on the rear wheels in the parking brake engagement direction based on the parking brake on signal. Accordingly, a state exceeding the third target clamping force 53 (or referred to as a target clamping force) of the clamping force CF1 of the electro-mechanical brakes 1200 and 1400 provided on the rear wheels may be maintained for a predetermined time. The third target clamping force 53 may be a predetermined clamping force corresponding to the engaged state of the parking brake and may be greater than the first target clamping force 51.

If the clamping force CF1 exceeds the third target clamping force 53 for a predetermined period of time, the electro-mechanical parking brake controllers 120 and 140 may turn on the solenoid driver 301 of the electric ratchet unit 1513 (Solenoid On). According to the solenoid on of the solenoid driver 301, the pawl 303 may move in the direction of pushing the first drive pulley 1215. In addition, the electric mechanical parking brake controllers 120 and 140 may control the motors 1211 and 1411 to rotate the first drive pulley 1215 in the direction of disengagement of the parking brake.

When the parking brake is engaged 503, the rotation of the first drive pulley 1215 may stop, and the clamping force CF1 of the electro-mechanical brakes 1200 and 1400 corresponding to the target parking clamping force 53 may be maintained, as shown in FIG. 5.

Additionally, in the normal state of the parking brake, when the driver removes their foot from the brake pedal 10, the clamping force CF2 of the electro-mechanical parking brakes 1300 and 1500 may decrease.

Meanwhile, contrary to the graph result of FIG. 5, there have been cases where the parking brake of the electro-mechanical parking brakes 1200 and 1400 fails to engage even after the solenoid driver 301 of the electric ratchet unit 1513 is turned on (Solenoid On), due to internal and/or external factors of the brake system 1.

Accordingly, the brake system 1 performs re-engagement of the parking brake for the electro-mechanical parking brakes 1200 and 1400 to ensure that the parking brake is engaged.

Conventionally, there has been a problem such as a vehicle rollback due to a late re-engagement of the parking brake.

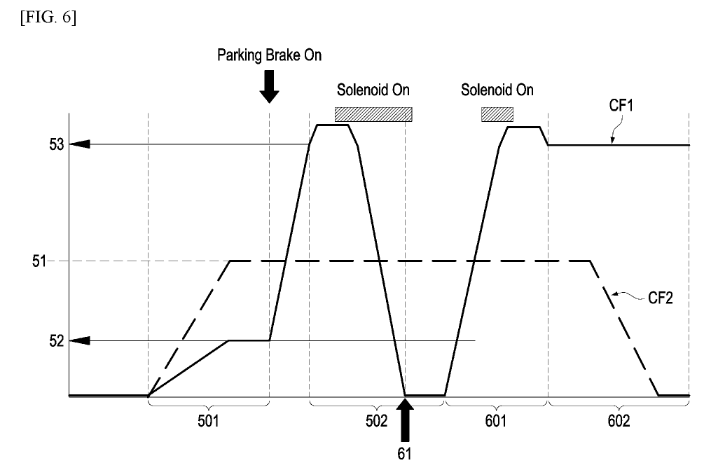

FIG. 6 is a graph illustrating a clamping force of a rear wheel electro-mechanical brake according to re-engagement control of a parking brake by a conventional brake system.

Referring to FIG. 6, conventionally, when the parking brake by the electro-mechanical parking brake is not properly engaged, the re-engagement control judgment 61 of the parking brake has been held until the clamping force CF1 of the electro-mechanical parking brake reaches zero. Due to the delay in the re-engagement judgment 61 as described above, the conventional electro-mechanical parking brake’s re-engagement operation 601 and the engagement of the parking brake 602 resulting from the re-engagement operation have been delayed. This caused the vehicle’s braking force to drop below a certain level and leading to problems such as a vehicle rollback when the vehicle is located on a hill.

In order to solve these conventional problems, the brake system 1 may control each electric mechanical parking brake differently from the conventional one to prevent the braking force of the vehicle from going below a certain level if the parking brake fails to engage.

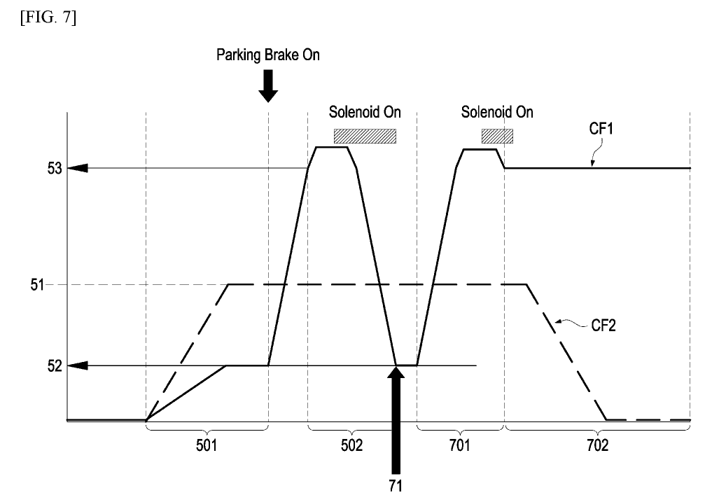

FIG. 7 is a graph illustrating clamping forces of front and rear electro-mechanical brakes 1200, 1300, 1400 and 1500 over time when the front and rear electro-mechanical brakes 1200, 1300, 1400, and 1500 are operated according to control of a brake system 1 according to one embodiment of the present disclosure.

Referring to FIG. 7, as described above in FIG. 5, each electro-mechanical brake controller 120, 130, 140, and 150 performs service braking control 501, and thereafter, the electro-mechanical brake controllers 120 and 140 may perform parking brake engagement control 502 of the electro-mechanical brakes 1200 and 1400, that is, turn on the solenoid driver 301 (Solenoid On) and rotate the first drive pulley 1215.

During the parking brake engagement control 502, that is, after the solenoid driver 301 is turned on, the electro-mechanical brake controllers 120 and 140 may identify whether the parking brake is engaged by the electro-mechanical brakes 1200 and 1400 until the clamping force CF1 of the parking brake reaches the second target clamping force 53.

If the parking brake is not engaged until the clamping force CF1 of the parking brake reaches the second target clamping force 53, the electro-mechanical brake controllers 120 and 140 may determine that re-engagement control of the parking brake of the electro-mechanical brakes 1200 and 1400 is necessary 71 and perform the re-engagement control of the parking brake 701.

The electro-mechanical parking brake controllers 120 and 140, based on the determination 71 that re-engagement control of the parking brake is necessary, may rotate the motors 1211 and 1411 of the electro-mechanical brakes 1200 and 1400 in the parking brake engagement direction. Accordingly, the clamping force CF1 of the electro-mechanical brakes 1200 and 1400 may exceed the third target clamping force 53, and the state in which the clamping force exceeds the third target clamping force 53 may be maintained for a predetermined period of time. If the clamping force CF1 maintains a state in which the clamping force CF1 exceeds the third target clamping force 53 for a predetermined time, the electro-mechanical brake controllers 120 and 140 may turn on the solenoid driver 301 of the electric ratchet unit 1513 (Solenoid On). According to the turn on of the solenoid drive unit 301, the pawl 303 may move in a direction to push the first drive pulley 1215. In addition, the electro-mechanical brake controllers 120 and 140 may control the motors 1211 and 1411 to rotate the first drive pulley 1215 in a direction to release the parking brake.

If the parking brake is engaged, the rotation of the first drive pulley 1215 stops, and as shown in FIG. 7, the clamping force CF1 of the electro-mechanical brakes 1200 and 1400 corresponding to the third target clamping force 53 may be maintained.

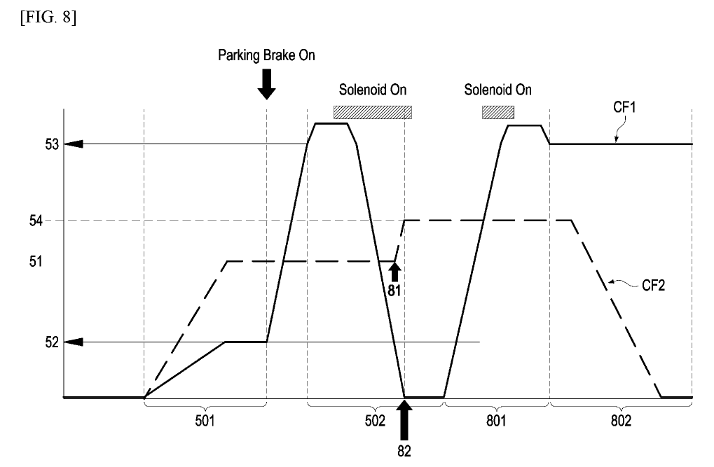

FIG. 8 is a graph illustrating clamping forces of front and rear wheel electro-mechanical brakes 1200, 1300, 1400 and 1500 over time when the front and rear wheel electro-mechanical brakes 1200, 1300, 1400 and 1500 are operated according to control of a brake system 1 according to one embodiment of the present disclosure.

Referring to FIG. 8, as described above in FIG. 5, each electro-mechanical brake controller 120, 130, 140, and 150 performs service braking control 501, and then the electro-mechanical brake controllers 120 and 140 may perform parking brake engagement control 502 of the electro-mechanical brakes 1200 and 1400, that is, turn on the solenoid driver 301 (Solenoid On) and rotate the first drive pulley 1215.

During the parking brake engagement control 502, that is, after the solenoid driver 301 is turned on (Solenoid On), the electro-mechanical brake controllers 120 and 140 may identify whether the parking brake of the electro-mechanical brakes 1200 and 1400 is engaged until the clamping force CF1 of the parking brake reaches the second target clamping force 53.

If the parking brake of the electro-mechanical brakes 1200 and 1400 is not engaged until the clamping force CF1 of the parking brake reaches the second target clamping force 53, the electro-mechanical brake controllers 120 and 140 may control the electro-mechanical brakes 1300 and 1500 to actively increase the clamping force CF2 of the electro-mechanical brakes 1300 and 1500 up to the fourth target clamping force 54. For example, the fourth target clamping force 54 may be a value greater than the first target clamping force 51 and smaller than the third target clamping force 53.

Additionally, when the clamping force CF1 of the electro-mechanical brakes 1200 and 1400 reaches zero, the electro-mechanical brake controllers 120 and 140 may determine that re-engagement control of the parking brake is necessary 82 and perform the re-engagement control 801.

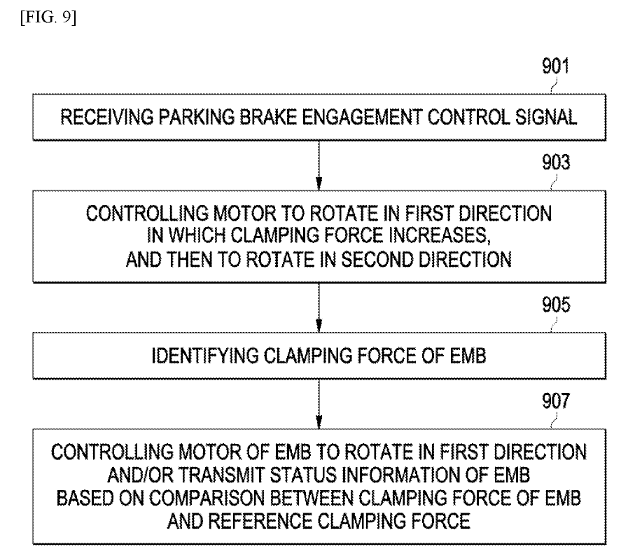

FIG. 9 is a flowchart illustrating operations of an electro-mechanical brake controller(e.g., a first electro-mechanical brake controller 120 and/or a third electro-mechanical brake controller 140) of a brake system 1 according to one embodiment of the present disclosure.

The electro-mechanical brake controller 120 and/or 140 may receive a parking brake engagement control signal from the controller 110 (901).

Based on the reception of the parking brake engagement control signal, the electro-mechanical brake controller 120 and/ or 140 may control the motor 1211 and/or 1411 of the electro-mechanical brake 1200 and/or 1400 to rotate in a first direction in which the clamping force increases, and then to rotate in a second direction opposite to the first direction (903).

Referring to FIGS. 7 and 8, while the motor 1211 and/or 1411 rotate in the first direction, if the clamping force CF1 of the electro-mechanical brake 1200 and/or 1400 exceeds a predetermined third target clamping force corresponding to the engagement of the parking brake for a predetermined period of time, the electro-mechanical brake controller 120 and/or 140 may control the motor 1211 and/or 1411 to rotate in the second direction.

The electro-mechanical brake controller 120 and/or 140 may identify the clamping force of the electro-mechanical brake 1200 and/or 1400 (905).

The electro-mechanical brake controller 120 and/or 140 may identify a clamping force generated according to the contact between the pad plates 211 and 213 and the brake disk 200 that is, the clamping force generated as the pad plates 211 and 213 press against the brake disc 200, based on the reception of a signal output from a current sensor (not shown) provided to sense the current of the motor 1211 and/or 1411.

The electro-mechanical brake controller 120 and/or 140 may identify the clamping force generated by the contact between the pad plates 211 and 213 and the brake disc 200, based on signals received from a force sensor (not shown) that detects the clamping force according to the contact between the pad plates 211 and 213 and the brake disc 200.

The electro-mechanical brake controller 120 and/or 140 may control the motor 1211 and/or 1411 of the electro-mechanical brake 1200 and/or 1400 to rotate in a first direction and/or transmit status information of the electro-mechanical brake 1200 and/or 1400 to the controller 110 based on a comparison between the clamping force of the electro-mechanical brake 1200 and/or 1400 and a reference clamping force (the second target clamping force 52 in FIGS. 5 to 8) (907).

The reference clamping force may be received from the controller 110, and may be a minimum clamping force for maintaining a stopped state of the corresponding wheel at a given slope of the road surface.

The controller 110 may identify the slope of the road surface where the vehicle is located based on the reception of a signal output from the vehicle’s acceleration sensor (not shown). In addition, the controller 110 may identify the road surface slope using various conventional techniques. Furthermore, the controller 110 may identify a reference clamping force corresponding to the identified road surface slope from pre-stored reference clamping forces, each corresponding to a road surface slope, and transmit the identified reference clamping force to the electro-mechanical brake controllers 120 and 140.

The electro-mechanical brake controller 120 and/or 140 may control the motor 1211 and/or 1411 to rotate in a first direction to perform re-engagement of the parking brake if, while controlling the motor(s) to rotate in a second direction as in the embodiment of FIG. 7, the parking brake of the electro-mechanical brake 1200 and/or 1400 is not engaged until the clamping force of the electro-mechanical brake 1200 and/or 1400 reaches the reference clamping force.

Identifying whether the first parking brake is engaged can be based on various signals. For example, it can be based on a signal from the motor position sensor indicating a lack of expected movement (i.e., the drive pulley has stopped rotating), a signal from a motor current sensor indicating a lack of expected electrical load (as the motor spins freely when the ratchet is not engaged), or a signal from a dedicated force or torque sensor directly measuring the clamping force.

The electro-mechanical brake controller 120 and/or 140 may identify whether the parking brake is engaged based on a signal output from a position sensor of the motor 1211 and/or 1411. For example, position information of the motor 1211 and/or 1411 corresponding to the engagement of the parking brake may be previously stored, and the electro-mechanical brake controller 120 and/or 140 may identify whether the parking brake is engaged based on a comparison between the previously stored position information corresponding to the engagement of the parking brake and position information acquired based on the signal output from the position sensor.

The electro-mechanical brake controller 120 and/or 140 may transmit status information of the electro-mechanical brake 1200 and/or 1400 to the controller 110 based on a comparison between the clamping force of the electro-mechanical brake 1200 and/or 1400 and a reference clamping force.

For example, the status information of the electro-mechanical brake 1200 and/or 1400 may include the clamping force of the electro-mechanical brake 1200 and/or 1400 and/or a difference value between the clamping force of the electro-mechanical brake 1200 and/or 1400 and the reference clamping force.

The controller 110 may transmit a control signal to the electro-mechanical brake controller 130 and/or 150 to control the electro-mechanical brake 1300 and/or 1500 to perform braking control as shown in FIG. 8, based on the reception of status information of the electro-mechanical brake 1200 and/or 1400.

For example, the control signal for controlling the electro-mechanical parking brake 1300 and/or 1500 may include a target braking clamping force of the electro-mechanical parking brake 130 and/or 150 (e.g., the fourth target braking clamping force 54 shown in FIG. 8).

The controller 110 may transmit a signal including a target braking clamping force corresponding to the current road surface slope where the vehicle is located, among pre-stored target braking clamping forces, each corresponding to a road surface slope, to the electro-mechanical brake controller 130 and/or 150.

The electro-mechanical brake controller 130 and/or 150 may increase the clamping force CF2 of the electro-mechanical brake 1300 and/or 1500 as shown in the embodiment of FIG. 8, based on the reception of a control signal from the controller 110. That is, if, while the electro-mechanical brake controllers 120 and/or 140 control the motors 1211 and/or 1411 to rotate in a second direction, the parking brakes of the electro-mechanical brakes 1200 and/or 1400 are not engaged until the clamping force of the electro-mechanical brakes 1200 and/or 1400 reaches the reference clamping force, the electro-mechanical brake controllers 130 and/or 150 may increase the clamping force CF2 of the electro-mechanical parking brakes 1300 and/or 1500 based on the reception of a control signal from the controller 110.

Additionally, as shown in FIG. 8, when the clamping force CF1 of the parking brake becomes zero, the electro-mechanical brake controllers 120 and/or 140 may determine that re-engagement control of the parking brake is necessary (82) and perform the re-engagement control (701).

The brake system and control method according to the above embodiments can prevent the vehicle from rolling backward on a slope, such as a hill, during the re-engagement of the parking brake by the electro-mechanical brake, thereby preventing accidents and alleviating the driver’s anxiety about vehicle rollback.

For example, the brake system and control method can quickly determine the necessity of re-engagement of the parking brake and promptly execute the re-engagement when the parking brake is not engaged during the engagement control of the parking brake by the electro-mechanical brake.

Additionally, if the parking brake is not engaged during the engagement control of the electro-mechanical brake provided on the vehicle’s rear wheels, the brake system and control method can assist the vehicle’s braking force through the braking control of the electro-mechanical brakes provided on the front wheels, and additionally perform re-engagement of the parking brake on the rear wheels.

Meanwhile, the disclosed embodiments may be implemented in the form of a recording medium that stores instructions executable by a computer. The instructions may be stored in the form of program codes, and when executed by a processor, the instructions may perform operations of the disclosed embodiments by generating a program module. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium, wherein the term 'non-transitory' simply means that the storage medium is a tangible device, and does not include a signal (e.g., an electromagnetic wave), but this term does not differentiate between where data is semi-permanently stored in the storage medium and where the data is temporarily stored in the storage medium.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

What is claimed is:

1. A brake system comprising:
a first electro-mechanical brake including a first motor and a ratchet unit and configured to brake a first wheel based on driving the first motor and to engage or disengage a first parking brake through operating the ratchet unit;
a first electro-mechanical brake controller configured to control the first motor and the ratchet unit; and
a controller electrically connected or communicatively connected to the first electro-mechanical brake controller,
wherein the first electro-mechanical brake controller is configured, based on receiving an engagement control signal of the first parking brake from the controller, to control the first motor to rotate in a first direction, in which a clamping force increases, and then to rotate in a second direction opposite to the first direction, and
wherein, during control of the first motor to rotate in the second direction, the first electro-mechanical brake controller is configured to perform at least one of controlling the first motor to rotate in the first direction or transmitting status information of the first electro-mechanical brake, based on a comparison between a first clamping force of the first electro-mechanical brake and a reference clamping force.

2. The brake system of claim 1, wherein the first electro-mechanical brake controller is configured to control the first motor to rotate in the first direction if the first parking brake is disengaged until the first clamping force of the first electro-mechanical brake reaches the reference clamping force during control of the first motor to rotate in the second direction.

3. The brake system of claim 2, wherein the first electro-mechanical brake controller is configured to identify whether the first parking brake is engaged based on a signal output from a position sensor of the first motor during control of the first motor to rotate in the second direction.

4. The brake system of claim 3, wherein the first electro-mechanical brake further includes a drive pulley configured to rotate based on driving force of the first motor, and
wherein the ratchet unit is configured to engage or disengage the first electro-mechanical brake based on rotational force of the drive pulley.

5. The brake system of claim 4, wherein the first electro-mechanical brake controller is configured
to identify whether the drive pulley is rotating based on the signal output from the position sensor of the first motor during control of the first motor to rotate in the second direction, and
to identify that the first parking brake is engaged if the drive pulley is not rotating.

6. The brake system of claim 1, in response to control of the first motor to rotate in the first direction, the first electro-mechanical brake controller is configured to control the first motor to rotate in the second direction based on a clamping force generated by the first electro-mechanical brake exceeding a target clamping force of the first parking brake for a preset time.

7. The brake system of claim 1, further comprising:
a second electro-mechanical brake including a second motor and configured to brake a second wheel based on driving of the second motor, and
a second electro-mechanical brake controller configured to control the second motor,
wherein the controller is configured to transmit a control signal including a target braking clamping force to the second electro-mechanical brake controller based on reception of the status information from the first electro-mechanical brake controller, and
wherein the second electro-mechanical brake controller is configured to control the second motor such that a second clamping force of the second electro-mechanical brake increases based on reception of the control signal including the target braking clamping force.

8. The brake system of claim 7, wherein the controller is configured
to identify disengagement of the first parking brake until a first clamping force of the first electro-mechanical brake reaches the reference clamping force, during control of the first motor to rotate in the second direction based on reception of the status information, and
to transmit a control signal including the target braking clamping force to the second electro-mechanical brake controller based on identification of disengagement of the first parking brake.

9. The brake system of claim 7, wherein the controller is configured
to identify a slope of a road surface where a vehicle having the brake system is located based on reception of a signal output from an acceleration sensor of the vehicle, and
to identify the reference clamping force corresponding to the slope of the road surface among pre-stored reference clamping forces, each corresponding to a road surface slope,
wherein the first electro-mechanical brake controller is configured to receive the reference clamping force from the controller.

10. The brake system of claim 9, wherein the controller is configured to identify the target braking clamping force corresponding to the slope of the road surface among the pre-stored reference clamping forces.

11. A control method of a brake system comprising a first electro-mechanical brake including a first motor and a ratchet unit and configured to brake a first wheel based on driving the first motor and to engage or disengage a first parking brake through operating the ratchet unit, a first electro-mechanical brake controller configured to control the first motor and the ratchet unit, and a controller electrically connected or communicatively connected to the first electro-mechanical brake controller, the control method comprising:
controlling, by the first electro-mechanical brake controller, the first motor to rotate in a first direction, in which a clamping force increases, and then to rotate in a second direction opposite to the first direction, based on receiving an engagement control signal of the first parking brake from the controller; and
during control of the first motor to rotate in the second direction, performing, by the first electro-mechanical brake controller, at least one of controlling the first motor to rotate in the first direction or transmitting status information of the first electro-mechanical brake, based on a comparison between a first clamping force of the first electro-mechanical brake and a reference clamping force.

12. The control method of claim 11, wherein the controlling of the first motor to rotate in the first direction is performed, based on the first parking brake being disengaged until the first clamping force of the first electro-mechanical brake reaches the reference clamping force during control of the first motor to rotate in the second direction.

13. The control method of claim 12, further comprising:
identifying whether the first parking brake is engaged based on a signal output from a position sensor of the first motor during control of the first motor to rotate in the second direction.

14. The control method of claim 13, wherein the first electro-mechanical brake further includes a drive pulley configured to rotate based on driving force of the first motor, and
wherein the ratchet unit is configured to engage or disengage the first electro-mechanical brake based on rotational force of the drive pulley.

15. The control method of claim 14, wherein the identifying of the whether the first parking brake is engaged includes
identifying whether the drive pulley is rotating based on the signal output from the position sensor of the first motor during control of the first motor to rotate in the second direction, and
identifying that the first parking brake is engaged if the drive pulley is not rotating.

16. The control method of claim 11, wherein the controlling of the first motor to rotate in the second direction is performed based on a clamping force generated by the first electro-mechanical brake exceeding a target clamping force of the first parking brake for a preset time in response to control of the first motor to rotate in the first direction.

17. The control method of claim 11, wherein the brake system further comprises:
a second electro-mechanical brake including a second motor and configured to brake a second wheel based on driving of the second motor, and
a second electro-mechanical brake controller configured to control the second motor,
wherein the control method further comprises:
transmitting, by the controller, a control signal including a target braking clamping force to the second electro-mechanical brake controller based on reception of the status information from the first electro-mechanical brake controller, and
controlling, by the second electro-mechanical brake controller, the second motor such that a second clamping force of the second electro-mechanical brake increases based on reception of the control signal including the target braking clamping force.

18. The control method of claim 17, wherein the transmitting of the control signal including the target braking clamping force to the second electro-mechanical brake controller includes
identifying, by the controller, disengagement of the first parking brake until a first clamping force of the first electro-mechanical brake reaches the reference clamping force, during control of the first motor to rotate in the second direction based on reception of the status information, and
transmitting, by the controller, a control signal including the target braking clamping force to the second electro-mechanical brake controller based on identification of disengagement of the first parking brake.

19. The control method of claim 17, further comprising:
identifying, by the controller, a slope of a road surface where a vehicle having the brake system is located based on reception of a signal output from an acceleration sensor of the vehicle, and
identifying, by the controller, the reference clamping force corresponding to the slope of the road surface among pre-stored reference clamping forces, each corresponding to a road surface slope.

20. The control method of claim 19, further comprising:
identifying, by the controller, the target braking clamping force corresponding to the slope of the road surface among the pre-stored reference clamping forces.
